(19) United States
(12) Patent Application Publication
(10) Pub. No.: US 2007/0299607 A1
(43) Pub. Date: Dec. 27, 2007

(54) Driving directions with landmark data

(75) Inventor: Pedro Antonio Cubillo, Medford, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Laboratories Inc.

(21) Appl. No.: 11/474,993

(22) Filed: Jun. 27, 2006

(51) Int. Cl. G01C 21/32

(52) U.S. Cl. 701/211

(57) ABSTRACT

In one of many possible embodiments, an exemplary system includes a landmark data subsystem providing landmark data and a driving directions subsystem communicatively coupled to the landmark data subsystem. The driving directions subsystem is configured to generate driving directions in response to a request received from an access device. The driving directions include a least a subset of the landmark data, which is representative of one or more landmarks located along a route defined by the driving directions. The driving directions subsystem is further configured to provide data representative of the driving directions to the access device. In certain embodiments, the driving directions subsystem is configured to provide to the access device a selection tool enabling a user of the access device to select between displaying and hiding the landmark data.

### BACKGROUND INFORMATION

Computerized applications have been developed for generating and providing driving directions in response to user requests. For example, a user may access a conventional driving direction application, identify a starting location and a destination location, and receive in return textual driving directions descriptive of a driving route between the locations and/or one or more geographic maps of a geographic area associated with the locations.

Traditional driving direction applications generate street-based driving instructions for navigating a driving route. That is, the driving route and instructions are conventionally described in relation to street names. For example, a driving step in traditional computer-generated driving directions may state, “Turn right at Oak Street.” Some conventional driving direction applications also provide street-based maps that visually illustrate driving routes relative to street names.

Unfortunately, computer-generated driving directions that present information in relation to street names are not user friendly, especially when a driver may not be able to easily read street names from a distance or when a driver is navigating an area at night. A driver reading street names in an unfamiliar area must concentrate on street signs in order to decipher the corresponding street names. This may distract the driver from the surrounding driving conditions and lead to uncertainty, abrupt actions, and potentially dangerous situations. For example, it is not uncommon for a driver reading street names to recognize a particular street name on a street sign only when the driver is already close enough to the corresponding street that the driver must abruptly brake and turn his vehicle in a surprising or potentially dangerous manner in order to turn onto the street. Another common problem is a driver not seeing a particular street sign because the street sign was not readily visible or because the driver was concentrating on other aspects of driving as he passed the sign.

For at least these reasons, there is a need for systems and methods that provide users with more user-friendly driving directions, including information that facilitates less-stressful navigation of unfamiliar driving routes.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical reference numbers designate identical or similar elements.

FIG. 1 is a block diagram illustrating an exemplary system for providing landmark data with driving directions, according to an embodiment.

FIG. 2 illustrates an exemplary graphical user interface view displaying data representative of driving directions, according to an embodiment.

FIG. 3 illustrates an exemplary graphical user interface view having landmark data presented as part of the driving directions of FIG. 1, according to an embodiment.

FIG. 4 illustrates an exemplary graphical user interface view having landmark selection tools presented along with the driving directions of FIG. 3, according to an embodiment.

FIG. 5 is a block diagram illustrating another exemplary system for providing landmark data with driving directions, according to an embodiment.

FIG. 6 is a flowchart illustrating an exemplary process for providing landmark data with driving directions, according to an embodiment.

### DETAILED DESCRIPTION OF PREFERRED EMBODIMENTS

### I. Introduction

Preferred embodiments may be implemented as systems and methods for providing landmark data with driving directions. The systems and methods provide one or more tools by which users request and receive computer-generated driving directions having landmark data. The landmark data is representative of one or more landmarks located along and/or visible from a driving route. As used herein, the term “landmark” refers to a visual point along a driving route. Landmarks may include any visually noticeable structure, object, or place other than a street, a street name, or street topology. Examples of landmarks include, but are not limited to, buildings (e.g. office buildings), businesses, parks, structures, hotels, eateries, coffee shops, restaurants, bars, clubs, post offices, delivery services pick-up and/or drop-off locations, laundry service locations, fuel stations, convenience stores, grocery stores, shopping malls, retail stores, business chain stores, vehicle dealerships, repair shops, recreation centers, car rental locations, airports, financial institutions (e.g., banks), police stations, fire stations, docks, boat ramps, zoos, theme parks, theaters, museums, historical sites, libraries, stadiums, hospitals, urgent care facilities, health service provider facilities, golf courses, sports facilities, gyms, schools, warehouses, storage sites, government sites, recreational areas, retirement communities, religious sites or structures, nursing homes, apartment complexes, residential communities, visitor centers, well-known structures or sites, etc. In certain embodiments, landmarks include one or more visual points having street addresses, which can be used to associate appropriate landmarks with driving routes, as described below.

The term “landmark data” refers to any representation of information descriptive of one or more landmarks. Landmark data may include landmark identifiers (e.g., landmark names such as names of retail businesses) and/or landmark attributes, including, but not limited to, color, shape, size, etc. Exemplary landmark data representative of landmarks will be described in more detail further below.

The inclusion of landmark data in driving directions provides user-friendly driving information that is naturally usable by drivers. In general, landmarks are easier to see than street names, and being able to see landmarks from a distance can help reduce uncertainty, sudden driving maneuvers, driving distractions, the burden of having to read every street sign, and the stress associated with navigating an unfamiliar driving route.

In certain embodiments, tools are provided that enable users to select whether or not landmark data will be displayed as part of the driving directions. In certain embodiments, for example, a selection tool is provided to users and enables the users to select whether to display or hide landmark data. This provides users with capabilities for flexibly controlling what information will be shown as part of computer-generated driving directions. Exemplary selection tools will be described further below.

The systems and methods can be used to generate revenue. For example, advertisers may be charged a fee for inclusion and/or prioritization of their landmarks in driving directions. Businesses or other advertisers may bid for inclusion and/or prioritization of their landmarks. Advertisers can be charged using any suitable billing arrangement, including a “pay-per-inclusion” arrangement, an example of which is described further below.

Components and functions of exemplary embodiments of systems and methods for providing landmark data with driving directions will now be described in detail.

### II. Exemplary System Views

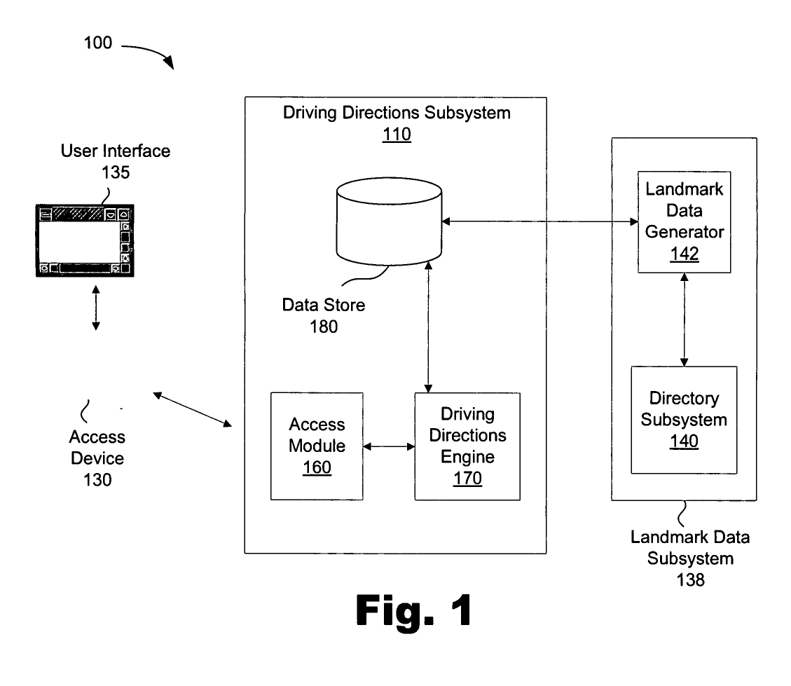

FIG. 1 illustrates an example of a system 100 for providing landmark data with driving directions, according to an embodiment. As shown in FIG. 1, the system 100 may include a driving directions subsystem 110 configured to communicate with an access device 130 that is configured to present a user interface 135 for consideration by a user of the access device 130. The system further includes a landmark data subsystem 138 configured to communicate with the driving directions subsystem 110 as shown in FIG. 1. The landmark data subsystem 138, which includes a directory subsystem 140 and a landmark data generator 142, provides landmark data to the driving directions subsystem 110. The driving directions subsystem 110, which includes an access module 160, driving directions engine 170, and data store 180, is configured to generate and provide driving directions having landmark data to the access device 130, as described below.

The elements of the system 100 may communicate using any known communication technologies, devices, media, and protocols supportive of data communications, including, but not limited to, the Internet, intranets, local area networks, wide area networks, cellular telephone networks, wireless networks, optical fiber networks, satellite networks, telephone networks, other communications networks, data transmission media, communications devices, Transmission Control Protocol (“TCP”), Internet Protocol (“IP”), File Transfer Protocol (“FTP”), telnet, Hypertext Transfer Protocol (“HTTP”), socket connections, Ethernet, data bus technologies, and other suitable communications technologies.

In certain embodiments, the elements of the system 100 are implemented in one or more computers. The system 100 may include any computer hardware and/or instructions (e.g., software programs), or combinations of software and hardware, configured to perform the processes described herein. In particular, it should be understood that the driving directions subsystem 110 and the landmark data subsystem 138 may be implemented on one or more than one physical computing device. Accordingly, the system 100 may include any one of a number of well-known computing devices (e.g., one or more servers), and may employ any of a number of well-known computer operating systems, including, but by no means limited to, known versions and/or varieties of the Microsoft Windows® operating system, the Unix operating system, and the Linux operating system.

Accordingly, the processes described herein may be implemented at least in part as instructions executable by one or more computing devices, as is well known. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

While an exemplary system 100 is shown in FIG. 1, the exemplary components illustrated in the Figure are not intended to be limiting. Indeed, other alternative hardware environments and implementations may be used, as is well known. Each of the components of the system 100 will now be described in additional detail.

A. Access Device

The access device 130 may include any device physically or remotely accessible to one or more users (e.g., users requesting driving directions from the driving directions subsystem 110) and that allows a user to provide input to and receive output from the driving directions subsystem 110. For example, the access device 130 can include, but is not limited to, one or more desktop computers, laptop computers, tablet computers, personal computers, kiosks, personal data assistants, cellular telephones, satellite pagers, wireless internet devices, embedded computers, video phones, network interface cards, mainframe computers, mini-computers, programmable logic devices, vehicles, personal communication devices, and any other devices capable of communicating with the driving directions subsystem 110. The access device 130 can also include various peripherals such as a terminal, keyboard, keypad, mouse, screen, printer, stylus, input device, output device, or any other apparatus that can help a user interact with the access device 130.

The access device 130 may be communicatively coupled to the driving directions subsystem 110 using any suitable communication technologies, including any of the communication technologies listed above. In certain embodiments, the access device 130 and the driving directions subsystem 110 are configured to communicate via the Internet or World Wide Web, as is well known.

The access device 130 provides access to the driving directions subsystem 110. Accordingly, one or more users may utilize the access device 130 to provide requests to and receive output from the driving directions subsystem 110. In particular, users are able to use the access device 130 to provide requests for driving directions to the driving directions subsystem 110. The requests may include data representative of one or more geographic locations or areas, including a starting location and a destination location. The locations may be identified by street addresses, city identifiers, state identifiers, territory identifiers, zip codes, airport codes, Global Positioning System coordinates, other suitable location identifiers, or any combination thereof, as is well-known.

Output from the driving directions subsystem 110 may be provided to the access device 130 and may include driving directions having landmark data. Examples of driving directions generated and outputted by the driving directions subsystem 110 are described further below. The access device 130 can present data representative of the driving directions and related information in the user interface 135 for consideration by the user of the access device 130.

The access device 130 may include instructions for generating and operating the user interface 135. The instructions may be in any computer-readable format, including software, firmware, microcode, and the like. When executed by a processor (not shown) of the access device 130, the instructions may present the user interface 135 to a user of the access device 130, as is well known.

While FIG. 1 shows a single access device 130, this is only illustrative. One or more access devices 130 may communicate with and benefit from messages and/or data provided by the driving directions subsystem 110.

B. User Interface

The access device 130 may present the user interface 135 to a user as a way for the user to initiate communications with and/or consider output from the driving directions subsystem 110. The user interface 135 may be equipped to present information to and receive input from users. As described below, for example, the user interface may present data representative of driving directions and tools for controlling the presentation of the driving directions to a user of the access device 130.

The user interface 135 may comprise one or more graphical user interfaces (“GUI”) capable of displaying information and receiving input from users. In certain exemplary embodiments, the user interface 135 includes a web browser, such as Internet Explorer® offered by Microsoft Corporation of Redmond, Wash.

However, the user interface 135 is not limited to a web form embodiment and may include many different types of user interfaces that enable users to utilize the access device 130 to communicate with the driving directions subsystem 110. In some embodiments, for example, the user interface 135 may include a voice interface capable of receiving input from and providing output to a user. Merely by way of example, the user interface 135 may include voice recognition applications. Accordingly, users may be able to provide requests and receive corresponding driving directions in audio format. Driving directions in audio format can be especially beneficial to users who do not want to read driving directions while driving.

C. Landmark Data Subsystem

The landmark data subsystem 138 may include any device or combination of devices and communication technologies useful for communicating with the driving directions subsystem 110. The landmark data subsystem 138 may also include any device or combination of devices and data storage and processing technologies useful for storing and processing data, including data useful for generating landmark data. The exemplary components of the landmark data subsystem 110 will now be described.

1. Directory Subsystem

The directory subsystem 140 may include any device or combination of devices and data storage and processing technologies useful for storing and managing directory data, including data commonly included in electronic yellow pages directories. As is well known, such data may include, but is not limited to, business listings and related information (e.g., business names, street addresses, contact information, and descriptions of products and/or services provided by the businesses). As described below, the data stored in the directory subsystem 140 may be used to generate landmark data to be stored in the data store 180 and for inclusion in driving directions.

2. Landmark Data Generator

The landmark data generator 142 may be configured to extract data from one or more electronic data sources and use the extracted data to generate landmark data. For example, the landmark data generator 142 shown in FIG. 1 may include any suitable communication technologies for communicating with the directory subsystem 140, including technologies for extracting data from the directory subsystem 140. As mentioned above, the directory subsystem 140 may include directory data such as electronic data associated with yellow pages type directories. The landmark data generator 142 may be configured to query the directory subsystem 140 and extract data, or at least a subset of the data representative of directory listings. In certain embodiments, the landmark data generator is configured to extract a listing identifier (e.g., a business name) and a street address corresponding with the listing identifier. Of course, additional data may be extracted.

The extracted data may be stored as landmark data in the data store 180. In this manner, the landmark data generator 142 is able to populate the data store 180 with landmark data obtained from data stored in the directory subsystem 140. Of course, the landmark data generator 142 may be configured to extract data from more than one source, including multiple directory subsystems. The landmark data generator 142 may also be configured to update the landmark data stored in the data store 180 to reflect updates to the data stored in the directory subsystem 140.

D. Driving Directions Subsystem

The driving directions subsystem 110 may include any device or combination of devices and communication technologies useful for communicating with the access device 130 and landmark data subsystem 138. The driving directions subsystem 110 may also include any device or combination of devices and data storage and processing technologies useful for storing and processing data, including data useful for generating representations of driving directions having landmark data. The components of the driving directions subsystem 110 will now be described.

1. Data Store

The data store 180 may include one or more data storage mediums, devices, or configurations and may employ any type, form, and combination of well-known storage media, including hard disk drives, read-only memory, caches, databases, optical media, and random access memory. Data store 180 may include any known technologies useful for storing, updating, modifying, accessing, retrieving, deleting, and managing data.

The data store 180 may store any data useful for the generation of driving directions having landmark data. For example, the data store 180 may include Geocode data, map data, addresses, listings, and other driving directions data useful for generating driving directions, as is well known. In addition, the data store 180 includes landmark data representative of landmarks. The landmark data may be used to generate driving directions having landmark data included therein. In certain embodiments, the landmark data includes, but is not limited to, landmark identifiers (e.g., landmark names such as McDonald's®) and street addresses associated with the landmarks. The landmark data may also include additional landmark information such as descriptors of landmark attributes.

The data stored in the data store 180 may be provided and/or maintained manually, automatically, or with a combination of manual and automatic steps. In certain embodiments, for example, landmark data may be manually defined and stored in the data store 180. In other embodiments, the landmark data generator 142 may automatically store and update landmark data in the data store 180.

2. Driving Directions Engine

The driving directions engine 170 is configured to receive and fulfill requests for driving directions. The driving directions engine 170 typically receives such requests from the access module 160, which has received the requests from the access device 130, as described below. When a request for driving directions between two specified locations is received, the driving directions engine 170 may query the data store 180 for data useful for generating driving directions to fulfill the request. In certain embodiments, the driving directions engine 170 is configured to use data stored in the data store 180 to generate conventional driving directions, as is well known. In addition, the driving directions engine 170 is configured to use landmark data stored in the data store 180 to augment the conventional driving directions. In other words, appropriate landmark data may be identified and incorporated into or appended to the conventional driving directions.

To illustrate, in response to a request, the driving directions engine 170 may generate street-based driving directions between two locations, as is well known. The driving directions engine 170 also searches the landmark data in the data store 180 to identify data representative of landmarks located along and/or visible from the driving route defined by the street-based driving directions. For example, for specific segments of streets included in the driving directions, the driving directions engine 170 is able to search the landmark data for street addresses located along the street segments. Accordingly, street names and street numbers included in the landmark data can be used to identify landmarks that are located along driving routes.

The driving directions engine 170 incorporates the identified landmark data to the street-based driving directions. In certain embodiments, the driving directions include multiple steps, and various ones of the steps may have one or more landmarks associated therewith. Of course, landmarks may not be associated with all driving steps. For example, the data store 180 may not include data representative of landmarks that are visible along a particular street segment associated with a driving step.

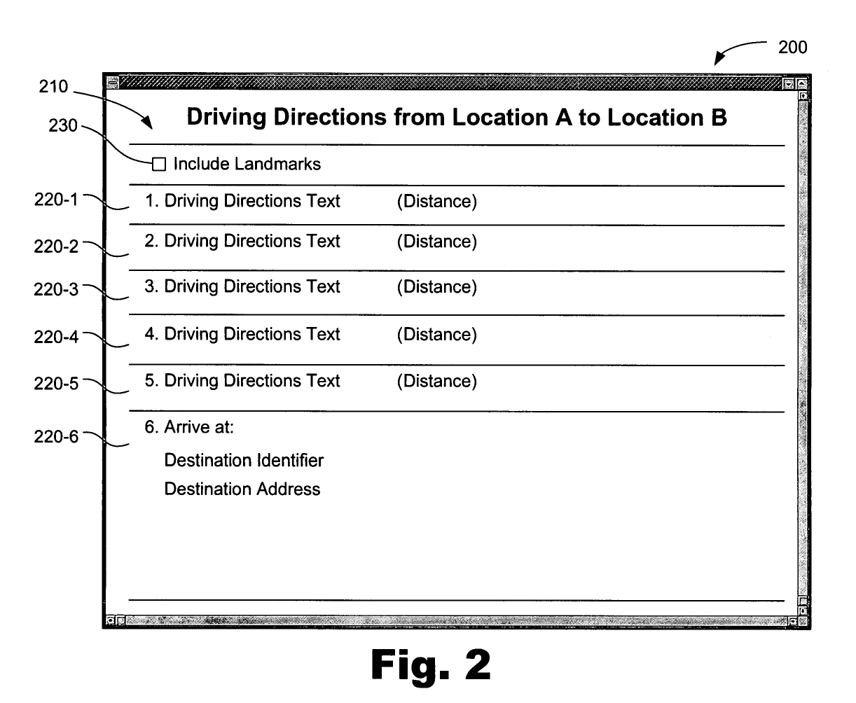

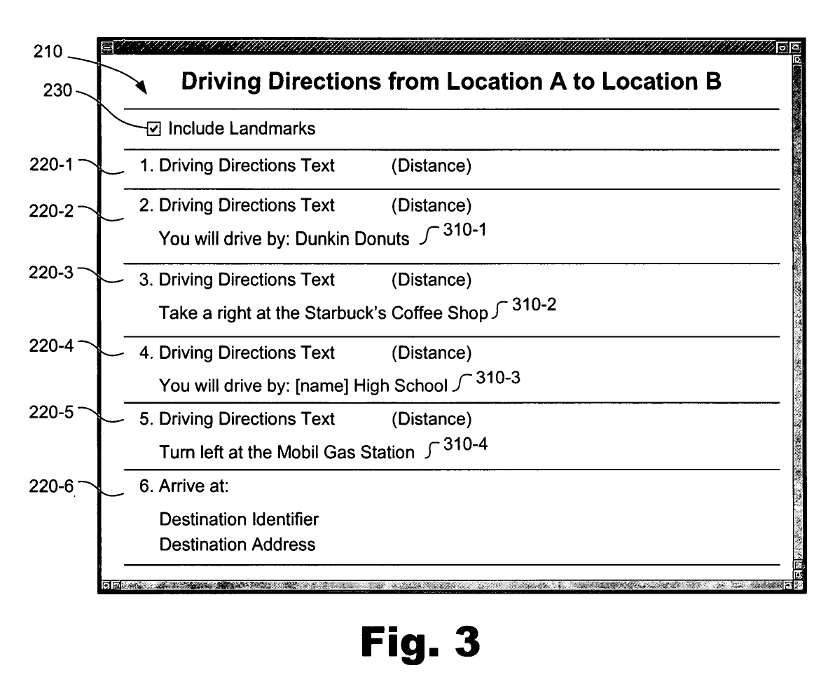

The driving directions engine 170 may provide the generated driving directions having landmark data to the access module 160 to fulfill corresponding requests for the driving directions. The output from the driving directions engine 170 may be in any suitable data format(s) and may include any acceptable representation of driving directions. The generated driving directions may include, but is not limited to, textual, audible, visual (e.g., maps), and other suitable representations of driving routes, landmark data, and related information. Examples of driving directions having landmark data will be described below in relation to FIGS. 2 and 3.

3. Access Module

The access module 160 may include any suitable communication technologies for communicating with the driving directions engine 170 and the access device 130. In certain embodiments, the access module 160 includes or is implemented in one or more servers configured to communicate with the access device 130. The communications between the access module 160 and the access device 130 may be transmitted over any suitable communication network, including the Internet or the World Wide Web, as is well known.

The access module 160 may be configured to receive from the access device 130 data representative of requests for driving directions, as described above. The requests may be forwarded from the access module 160 to the driving directions engine 170, which generates responses to the requests, as described above.

The access module 160 is configured to receive output (e.g., the responses to the requests) from the driving directions engine 170. The access module 160 processes the output, including ensuring that it is in suitable form for transmission to the access device 130. For example, the access module 160 may be configured to insert the output, including data representative of driving directions having landmark data, into Hypertext Markup Language (“HTML”) messages for transmission to the access device 130 using Hypertext Transport Protocol (“HTTP”). Of course, other suitable data formats and protocols may be used.

As described above, the access device 130 is able to receive output (e.g., data representative of driving directions) from the access module 160 and present data representative of the output in the user interface 135 for consideration by a user. FIG. 2 illustrates an exemplary graphical user interface (“GUI”) 200 that may be presented in the user interface 135. As shown in FIG. 2, the GUI 200 may include driving directions 210 having one or more driving direction steps 220-1 through 220-6 (referred to collectively as “the driving direction steps 220”). Each of the driving direction steps 220 includes a textual description of a driving instruction. These driving instructions are generally street-based instructions, as are well known. Examples of street-based instructions include “Turn right on Oak Street,” and “Turn left on Main Street,” for example.

The GUI 200 also includes a selection tool 230 that is selectable by a user of the access device 130 and that enables the user to select whether to display or hide landmark data. In FIG. 2, the selection tool 230 is not selected. Consequently, the landmark data is hidden from view. When the user selects the selection tool 230, landmark data associated with the driving direction steps 220 is displayed.

FIG. 3 illustrates the graphical user interface (“GUI”) 200 of FIG. 2 with the selection tool 230 having been selected by the user. As shown in FIG. 3, instances of landmark data 310-1 through 310-4 (collectively referred to as “the landmark data 310) are displayed along with the driving direction steps 220. The landmark data 310 can be associated with one or more of the driving direction steps 220. As shown in FIG. 3, for example, landmark data 310-1 is associated with driving direction step 220-2, landmark data 310-2 is associated with driving direction step 220-3, landmark data 310-3 is associated with driving direction step 220-4, and landmark data 310-4 is associated with driving direction step 220-5.

The landmark data 310 may include one or more descriptions of landmarks located along or visible from street segments associated with the driving direction steps 220. For example, landmark data 310-1 states, “You will drive by: Dunkin Donuts®,” where a Dunkin Donuts® store is a landmark along and/or visible from a segment of a driving route identified in driving direction step 220-2.

The landmark data 310 may include both turning points and status points. Status points describe landmarks that are located along a segment of a driving route and are potentially useful for measuring progress in navigating the segment. Landmark data 310-1 is an example of a status point. Turning points describe landmarks which are helpful for signaling when a driver should turn or take some other driving action (e.g., accelerate, decelerate, stop, etc.). Landmark data 310-2 states “Take a right at the Starbuck's® Coffee Shop” and is an example of a turning point.

It is anticipated that other embodiments may be configured to display landmark driving steps independently of street-based driving steps. For example, a user may be provided with a tool for selecting whether to view driving directions as street-based driving steps, landmark-based driving steps, or a combination of street and landmark driving steps. By providing users with the capability to select what information is displayed as part of driving directions, users are able to customize driving directions to fit specific user-preferences.

Driving directions having landmark data provide user-friendly information for navigating driving routes. Drivers are generally better equipped to identify visible landmarks rather than street names. Where street-based directions are suited for generation by computers, directions having landmarks are generally more helpful to drivers. For example, a driver will usually recognize a visible landmark such as a prominent business sign (e.g., McDonald's® sign) from a greater distance than the distance at which the driver will be able to recognize a street name on a street sign. Significantly, the inclusion of landmark data in driving directions can reduce the uncertainty, abrupt actions, stress, distractions, and potential dangers associated with relying on street-based directions when navigating an unfamiliar route.

The system 100 may be configured to enhance user-friendliness even further by providing users with a capability for selecting, from a group of landmarks, one or more preferred landmarks to be presented in the driving directions. For example, the system 100 may provide a landmark selection tool to a user, which tool enables the user to select, from a list of landmarks, one or more landmarks that the user would like to see displayed in the driving directions.

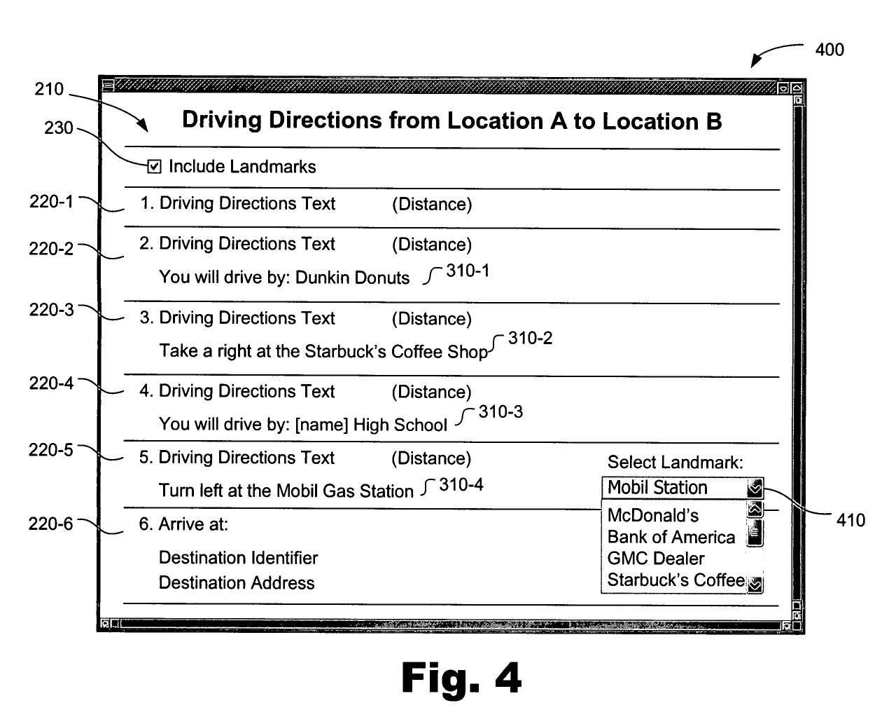

FIG. 4 illustrates an exemplary graphical user interface (“GUI”) 400 that may be presented in the user interface 135. As shown in FIG. 4, the GUI 400 may include the elements shown in FIG. 3, as well as a landmark selection tool 410 associated with the landmark data 310. In FIG. 4, the landmark selection tool 410 is associated with driving direction step 220-5.

The landmark selection tool 410 may be of any form and include any technology that enables the user to select one or more landmarks from a group of landmarks. For example, the exemplary landmark selection tool 410 shown in FIG. 4 includes a drop-down menu of landmarks from which the user is able to select one or more landmarks to be displayed in association with driving step 220-5. In certain embodiments, the list of landmarks in the drop-down menu includes landmarks having street addresses located along a street segment associated with driving direction step 220-5.

By way of an example, landmark data 310-4 includes the text “Turn left at the Mobil® Gas Station.” This particular landmark (i.e., a Mobil® gas station) may be a default landmark presented in the initially displayed landmark data. With the landmark selection tool 410, a user is able to select a different landmark for display. For instance, a user may select a particular bank landmark (e.g., Bank of America®) from the drop-down menu of the landmark selection tool 410. Landmark data descriptive of the selected bank will then replace the landmark data 310-4 descriptive of the Mobil® gas station landmark in driving direction step 220-5. In this manner, a user is able to select a preferred landmark for display in the driving directions.

The landmark selection tool 410 enables users to customize, based on individual preferences, the display of landmark data to fit user preferences and purposes. For example, a particular user may wish to have data representative of a gas station landmark (e.g., a Mobil® station) displayed in the driving directions in order to identify a location to stop for fuel. Another user may wish to have data representative of a particular eatery (e.g., a Wendy's® location) displayed in the driving directions in order identify a location to stop for food. Accordingly, the system 100 allows users to plan for stops along a driving route by choosing to display data representative of potentially helpful landmarks in driving directions. This feature can help users save time by identifying landmarks that allow the users to work stops and other tasks associated with the landmarks into travel plans.

While the landmark selection tool 410 is shown to be associated with driving direction step 220-5 in FIG. 4, this is not limiting. Landmark selection tools such as the landmark selection tool 410 may be associated with other ones of the driving direction steps 220 having landmark data. In certain embodiments, each of the driving direction steps 220 having more than one landmarks associated therewith may have a landmark selection tool by which a user is able to select for each such driving step 220 which landmark will have its landmark data displayed.

In certain embodiments, each driving direction step 220 will display landmark data for only one landmark at a time. In other embodiments, certain driving direction steps 220 can display landmark data for multiple landmarks. In such embodiments, the landmark data for different landmarks may be presented in an order that coincides with a direction of travel along a street segment. In certain embodiments, driving direction steps 220 having turning point landmark data are configured to display landmark data for only one landmark at a time, and driving direction steps 220 having status point landmark data are configured to display landmark data for one or more landmarks.

While the above description relates to driving directions having landmark data represented in textual form, the same or similar features may be provided with driving directions in audio, visual (e.g., geographic maps), or other form. For example, a geographic map of a driving route may include icons representative of landmarks located along the route. By way of another example, landmark data in driving directions may include visual images of landmarks.

E. Billing Subsystem

Advertisers may wish to have landmark data for specific landmarks included in driving directions. Accordingly, the system 100 may be configured to generate revenue by charging advertisers for the inclusion and/or prioritization of landmark data in driving directions. That is, inclusion and/or prioritization of landmark data in driving directions may be based on fees paid by advertisers associated with landmarks.

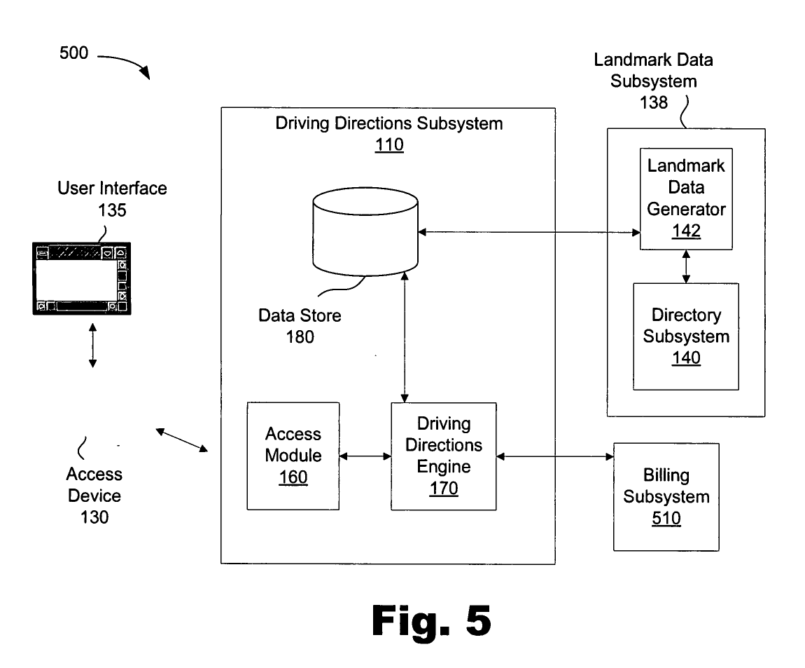

FIG. 5 is a block diagram illustrating another exemplary system 500 for providing landmark data with driving directions, according to an embodiment. As shown in FIG. 5, the system 500 includes the elements of the system 100 of FIG. 1. In addition, the system 500 of FIG. 5 includes a billing subsystem 510 configured to communicate with the driving directions subsystem 110 as shown. The billing subsystem 510 and the driving directions subsystem 110 may use any of the communication technologies described above to communicate with one another.

The billing subsystem 510 may be configured to track fees to be charged to advertisers in connection with the inclusion of advertiser landmark data in driving directions. In certain embodiments, for example, the billing subsystem 510 is configured to charge an advertiser for each inclusion of landmark data associated with the advertiser in driving directions. Such a billing arrangement may be referred to as a “pay-per-inclusion” or “pay-per-appearance” fee schedule. The billing subsystem 510 may receive, from the driving directions engine 170, data representative of the instances of landmark data being included in driving directions. The landmark data may include identifiers associated with and useful for identifying advertisers to be charged for the inclusions of landmark data instances in driving directions.

Any suitable fee arrangement may be used to charge advertisers. For example, advertisers may be asked to pay a flat fee to secure the right to have landmark data included in driving directions generated during a predefined time interval. By way of another example, advertisers may be asked to bid for the right to have their landmark data included driving directions.

Advertisers may also be charged for prioritization of landmark data. For example, advertisers may be asked to bid to establish a priority between landmark data associated with advertisers. A landmark associated with an advertiser having submitted the highest bid may be assigned priority over other landmarks. The priority of landmarks can be used to determine an order in which landmark data will be displayed in a list of landmarks such as the drop-down menu associated with the landmark selection tool 410 of FIG. 4. Thus, in certain embodiments advertisers are able to bid to increase the exposure of their landmark data. For example, two gas stations located on different corners of an intersection may bid against each other for priority positioning of their landmark data in driving directions.

The billing subsystem 510 may communicate information to the driving directions engine 170, which may use the information to determine the landmark(s) to be included in landmark data and/or the prioritization of landmarks included in landmark data. Accordingly, the system 500 can be used to generate advertising revenue in exchange for the inclusion and/or prioritization of landmark data in driving directions.

### III. Exemplary Process View

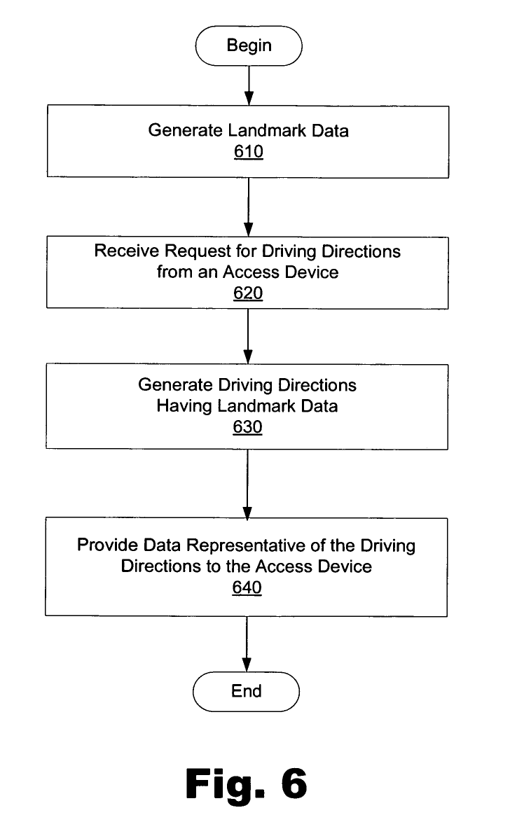

FIG. 6 is a flowchart illustrating an exemplary process for providing landmark data with driving directions, according to an embodiment. While FIG. 6 illustrates exemplary steps according to one embodiment, other embodiments may omit, add to, reorder, and/or modify any of the steps shown in FIG. 6.

In step 610, landmark data is generated. Step 610 may be performed in any of the ways described above, including using directory listings from one or more directory databases to manually or automatically define the landmark data.

In step 620, a request for driving directions is received from an access device such as the access device 130. Step 620 may be performed in any of the ways described above, including the driving directions subsystem 110 receiving the request.

In step 630, driving directions having landmark data are generated. The driving directions are generated based on and in response to the request. Step 630 may be performed in any of the ways described above. For example, the driving directions engine 170 may use data in the data store 180 to generate conventional street-based driving directions, and landmark data may be incorporated into the street-based driving directions, as described above.

In step 640, data representative of the driving directions is provided to the access device. Step 640 may be performed in any of the ways described above. For example, data representative of the driving directions may be inserted into one or more messages (e.g., HTML messages) that are then transmitted to the access device. The access device can present the view in a user interface (e.g., the user interface 135) for consideration by the user of the access device. The user can utilize any of the tools described above to manage the information presented in the driving directions.

Variations of the exemplary process illustrated in FIG. 6 may include one or more billing steps for charging advertisers fees for the inclusion and/or prioritization of landmark data in driving directions, as described above.

The above-described systems and methods provide user-friendly driving directions including landmark data. Tools are also provided that allow users to control the information that is presented in the driving directions. Certain provided tools also allow users to customize the landmark data included in driving directions to fit specific user preferences and situations. These and other features of the present systems and methods can help reduce uncertainties, sudden driving maneuvers, and stresses associated with navigating unfamiliar driving routes.

### IV. Alternative Embodiments

The preceding description has been presented only to illustrate and describe embodiments of the invention. It is not intended to be exhaustive or to limit the invention to any precise form disclosed. The invention may be practiced otherwise than is specifically explained and illustrated without departing from its spirit or scope. It is intended that the scope of the invention be defined by the following claims.

What is claimed is:

1. A system comprising:
a landmark data subsystem providing landmark data; and
a driving directions subsystem communicatively coupled to said landmark data subsystem and configured to
generate driving directions in response to a request received from an access device communicatively coupled to said driving directions subsystem, said driving directions including a least a subset of said landmark data representative of one or more landmarks located along a route defined by said driving directions, and
provide data representative of said driving directions to the access device.

2. The system of claim 1, wherein said driving directions subsystem is configured to generate said driving directions by:
generating street-based driving directions in response to the request, and
incorporating said at least a subset of landmark data into said street-based driving directions.

3. The system of claim 1, wherein each of said one or more landmarks has a street address located along the route.

4. The system of claim 1, wherein said at least a subset of landmark data includes at least one of a textual, visual, and audible description of said one or more landmarks.

5. The system of claim 1, wherein said one or more landmarks include one or more turning point landmarks and one or more status point landmarks.

6. The system of claim 1, wherein said driving directions subsystem is configured to provide to the access device a selection tool enabling a user of the access device to select between displaying and hiding said at least a subset of landmark data.

7. The system of claim 1, wherein when said one or more landmarks includes a plurality of landmarks, said driving directions subsystem is configured to provide to the access device a landmark selection tool enabling a user of the access device to select between different ones of said plurality of landmarks for display.

8. The system of claim 1, wherein said driving directions includes one or more driving direction steps, each of said driving direction steps including a street-based driving instruction, and wherein at least a subset of said driving direction steps also includes said at least a subset of landmark data.

9. The system of claim 1, wherein said landmark data subsystem includes a directory subsystem, and wherein one or more listings stored in said directory subsystem is used to generate said landmark data.

10. The system of claim 1, wherein said landmark data includes, for each of said one or more landmarks, a landmark identifier and a street address associated with said landmark.

11. The system of claim 1, further comprising a billing subsystem communicatively coupled to said driving directions subsystem, said billing subsystem being configured to charge one or more advertisers associated with said one or more landmarks a fee for at least one of inclusion and prioritization of said landmark data in said driving directions.

12. A system comprising:
a landmark data generator configured to use directory listings stored in a directory subsystem to generate landmark data, said landmark data representing one or more landmarks and including at least a landmark identifier and a street address for each of said one or more landmarks;
an access module configured to receive a request for driving directions from an access device communicatively coupled to said access module; and
a driving directions engine communicatively coupled to the access module and the landmark data generator and configured to
generate street-based driving directions in response to the request, said street-based driving directions identifying a route, and
incorporate at least a subset of said landmark data into said street-based driving directions, said at least a subset of said landmark data being representative of at least a subset of said one or more landmarks, said street address of each said landmark included in said at least a subset of said one or more landmarks being located along said route;
said access module being configured to provide to the access device data representative of said driving directions having said at least a subset of said landmark data.

13. A method comprising:
generating street-based driving directions in response to a request received from an access device;
incorporating landmark data into said street-based driving directions, said landmark data being representative of one or more landmarks located along a route defined by said driving directions; and
providing data representative of said driving directions having said landmark data to the access device.

14. The method of claim 13, wherein said incorporating step includes identifying each of said one or more landmarks as having a street address located along the route.

15. The method of claim 13, wherein said providing step includes providing at least one of a textual, visual, and audible description of said one or more landmarks for consideration by a user of the access device.

16. The method of claim 13, wherein said one or more landmarks include one or more turning point landmarks and one or more status point landmarks.

17. The method of claim 13, further comprising providing to the access device a selection tool enabling a user of the access device to select between displaying and hiding said landmark data.

18. The method of claim 17, further comprising:
displaying at least a subset of said landmark data when said selection tool is selected; and
hiding said at least a subset of said landmark data when said selection tool is unselected.

19. The method of claim 13, further comprising providing to the access device, when said one or more landmarks includes a plurality of landmarks, a landmark selection tool enabling a user of the access device to select between different ones of said plurality of landmarks for display.

20. The method of claim 13, further comprising presenting said driving directions for consideration by a user of the access device, said driving directions including one or more driving direction steps, each of said driving direction steps including a street-based driving instruction, and wherein at least a subset of said driving direction steps also includes said landmark data.

21. The method of claim 13, further comprising using one or more listings stored in a directory subsystem to generate said landmark data.

22. The method of claim 13, further comprising charging one or more advertisers associated with said one or more landmarks a fee for at least one of inclusion and prioritization of said landmark data in said driving directions.
